(19) United States
(12) Patent Application Publication
(10) Pub. No.: US 2013/0141052 A1
(43) Pub. Date: Jun. 6, 2013

(54) SYSTEM FOR STORING ELECTRICAL ENERGY

(71) Applicant: VOITH PATENT GMBH, Heidenheim (DE)

(72) Inventor: Conrad Rossel, Syrgenstein (DE)

(73) Assignee: VOITH PATENT GMBH, Heidenheim (DE)

(21) Appl. No.: 13/755,063

(22) Filed: Jan. 31, 2013

Related U.S. Application Data
(63) Continuation of application No. PCT/EP2011/004053, filed on Aug. 12, 2011.

(30) Foreign Application Priority Data
Aug. 31, 2010 (DE) 10 2010 036 002.3

(51) Int. Cl. H02J 1/00; H02J 7/00

(52) U.S. Cl. CPC H02J 1/00; H02J 7/0013
USPC 320/137; 307/29

(57) ABSTRACT

A system for storing electrical energy having several storage cells, each storage cell having an operating voltage, an electrical load and a switching element connected in series with each storage cell. The switching element being closed when a threshold voltage of the storage cell is reached or exceeded. The system including at least one module having several storage cells and a control device. The control device being configured to assign a temperature to individual storage cells and a module voltage to the module. The control device being further configured to alter the threshold voltage of the individual storage cells dependant upon the assigned temperature whilst maintaining the module voltage.

### CROSS REFERENCE TO RELATED APPLICATIONS

This is a continuation of PCT application No. PCT/EP2011/004053, entitled “A SYSTEM FOR STORING ELECTRICAL ENERGY”, filed Aug. 12, 2011, which is incorporated herein by reference.

### BACKGROUND OF THE INVENTION

1. Field of the Invention

The invention relates to a system and method for storing electrical energy.

2. Description of the Related Art

Systems for storing electrical energy, and especially for storing electrical tractive energy in electrical vehicles or hybrid vehicles, are known from the general state of the art. Such systems for storing electrical energy are typically arranged by way of individual storage cells which are electrically switched together in series and/or in parallel for example.

Principally, a large number of different storage battery cells or capacitors can be used as storage cells. As a result of the comparatively high energy quantities and powers in storing and retrieving energy, when used in drive trains for vehicles, and especially for commercial vehicles in this case, storage cells with an adequate energy content and high power are preferably used as storage cells. These can be storage battery cells in lithium-ion technology for example, or in particular, storage cells in the form of highly powerful double-layer capacitors. These capacitors are generally also known as supercapacitors, supercaps or ultra-capacitors.

Irrespective of whether supercapacitors or storage battery cells, with high energy content are used, the voltage of the individual storage cell is limited to an upper voltage value or threshold voltage as determined by its design, in the case of such configurations a plurality of storage cells are switched together in their entirety, or in blocks, in series with each other. If upper voltage value is exceeded during charging of the system for storing electrical energy, the service life of the storage cell will generally be reduced in a drastic fashion.

As a result of predetermined production tolerances, the individual storage cells typically slightly deviate from one another in their properties (such as self-discharge) in practice. This leads to the consequence that individual storage cells have a slightly lower voltage than other storage cells in the system. Since the maximum voltage generally remains the same for the entire system, and this represents the triggering criterion, which is especially typical during charging, it will inevitably occur that other storage cells will have a slightly higher voltage, and will then be charged during charging processes beyond the permitted voltage threshold. As already mentioned above, such excess voltage leads to a considerable reduction in the possible operational life span of the individual storage cells and therefore the system for storing electrical energy.

On the other hand, storage cells which have been reduced substantially in their voltage in the system for storing electrical energy can be subjected to polarity reversal, which also drastically reduces the operational life span.

In order to remedy this problem, the general state of the art substantially knows two different types of so-called cell voltage compensation techniques which are respectively arranged in a centralized or decentralized manner. In a central electronic system, all components are combined in a control unit, for example, whereas in the case of a decentralized configuration the individual components are attached in one or two storage cells to a small printed circuit board. The generally used terminology of cell voltage compensation is slightly misleading, in this case, because it is not the voltages—or more precisely the energies—of the individual storage cells which are compensated among each other, but the cells with high voltages are reduced with respect to their excessive voltages. Since the total voltage(s) of the system for storing electrical energy remain(s) constant, a cell whose voltage was reduced by the so-called cell voltage compensation technique can be increased again in its voltage over time, so that at least the likelihood of polarity reversal will be reduced.

In addition to passive cell voltage compensation, in which an electrical resistor is switched in parallel to each individual storage cell and therefore leads to a continuous undesirable discharge and also heating of the system for storing electrical energy, active cell voltage compensation is also used. An electronic threshold switch is additionally switched in parallel to the storage cell and in series with the resistor. This configuration, which is also known as bypass electronics, will only allow a current to flow when the operating voltage of the cell lies above a predetermined threshold voltage. Once the voltage of the individual storage cell drops to a range beneath the predetermined threshold voltage, the switch will be opened and no current will flow. Due to the fact that the electrical resistance will be deactivated by the switch when the voltage of the individual storage cells lies beneath the predetermined limit value, an undesirable discharge of the entire system for storing electrical energy can also be substantially avoided. A continual undesirable heat generation is also no problem in this problem-solving approach of active cell voltage compensation. There is no true compensation of the individual voltages of the cells among each other however by active cell voltage compensation. Instead, the storage cell will be discharged with a small bypass current upon exceeding the threshold voltage in order to limit the excess by slow reduction of the excess voltage. The bypass current will only flow for such a time until the system for storing electrical energy is discharged again which leads to the voltage falling beneath the respective voltage threshold and the switch being opened again.

The life span of the system for storing electrical energy is critical in hybrid drives, especially in hybrid drives for commercial vehicles such as a bus in city and metropolitan traffic. The system for storing electrical energy represents a considerable part of the costs for the hybrid drive as compared to conventional drive trains in power classes suitable for such applications. That is why it is especially important that very long operational life spans are achieved in such applications. In addition to the mentioned fact that the operating voltage of individual storage cells in the charging/discharge cycle may inadvertently exceed a threshold voltage; the operating temperature of the storage cell being a further parameter which relevantly influences the operational life span. The operational lifespan of double-layer capacitors depends strongly on the operating temperature and the applied voltage. There are differently effective cooling possibilities for the individual storage cells, especially when using energy storage systems during operation of a hybrid vehicle. For example, cooling air which has already cooled other storage cells or modules reaches some storage cells or modules. Since storage cells are switched in series, the storage cells switched in series carry the same current and therefore produce the same dissipated heat per storage cell. As a result of the unavoidable differences concerning the cooling of storage cells, different temperatures will occur from storage cell to storage cell.

What is needed in the art is a system for storing electrical energy which offers the longest possible operational life span and reduced failure probability.

### SUMMARY OF THE INVENTION

The system in accordance with the invention offers the advantage that the operational life span of the storage cells, which depends strongly on the temperature, will be taken into account. Since storage cells age more rapidly at higher temperature and can therefore lead to inoperativeness of the entire storage system despite the fact that the majority of the storage cells with a temperature history at a lower level are still functional, the invention provides that the voltage of cells which are actually, or presumably subjected to, a higher temperature will be assigned a lower voltage. This will be achieved, for example, by reducing the threshold voltage of the respective cells.

The temperature differences of the individual storage cells are caused, among other things, by the differently effective cooling of the individual storage cells. For example, part of the storage cells are supplied with cooling air which has already been heated by another part of the storage cells. Since the storage cells of one module are switched in series, each storage cell of the module generates approximately the same dissipated heat. The unavoidable differences in cooling lead to different storage cell temperatures. The operational life span of the storage cells is strongly dependent on ageing. Storage cells that are operated at a higher temperature level will age more rapidly and will lead, after their failure, to a total failure of the module or storage unit although the storage cells operated at a lower temperature level are still functional.

This in particularly relevant in applications of the storage system, in which high energy quantities are received or supplied, within a short period of time by the storage cells. This occurs, for example, in the recuperation of brake energy or during acceleration processes (boosting) for example. These charging/discharging cycles lead to a rapid release of large quantities of waste heat, by means of which the storage cells will heat up.

The ageing effects which commence at high temperatures, such as the decrease in the capacity and the increase in the internal resistance, are self-reinforcing to a high extent in such applications with regular high power requirements, as occur for example in the hybrid drives in city buses. The dissipated heat will increase further with the rise in the internal resistance, which heats the cell that already has a higher temperature even further and therefore leads to progressively faster ageing.

The solution in accordance with the invention remedies this problem in that the cells with the middle temperature retain their middle voltage, the cells with a higher temperature are assigned a lower voltage and the cells with a lower temperature are assigned a higher voltage. The voltage of the module therefore remains unchanged.

The required voltage decreases, and the required voltage increases, in relation to the middle cells, are obtained, for example, from the absolute temperature level and/or the temperature differences between the storage cells.

The temperatures assigned to the individual storage cells can be determined by means of sensors on each storage cell.

An especially preferred embodiment of the invention is manifested in such a way that the temperatures assigned to the individual storage cells are determined from model-based calculations. There will not be any measurement of the current temperature, thus preventing the costs concerning sensors, cabling and evaluation. Instead, the possible temperature distribution between the individual storage cells are determined from a thermal model and a simulation of the configuration, from life span models of the storage cell and/or empirically from tests. A substantially predictable temperature distribution is therefore obtained as a result of the arrangement of the storage cells in a module. It is determined for example by the position of the storage cells within the module, such as a position on the edge or in the middle, by the position of the module relative to the other modules, by the position within a superordinate module or with respect to other components relevant with respect to heat emission, or by the inflow direction of the air towards the storage cells or the module, by the airflow provided for the cooling. The airflow can also be produced by the speed of the vehicle.

There can be different strategies for setting the voltage values of the individual cells.

A lower voltage load can be chosen already in advance for storage cells for which a high thermal load is expected. One therefore does not wait until a respective cell temperature is reached and counteracts the effect by lowering the voltage. Instead, a voltage level is always set, which corresponds to an expected temperature of the cell. The determination of the temperature can additionally also be based on the current operating state, the operating situations to be expected and/or the environmental data. When using the storage system in a hybrid vehicle, these would include travel in the city and/or on highways, functionality of the cooling, measured outside temperature, climate height of the location of use etc. As a result, a constellation of voltage and temperature, which is unfavorable for the ageing of individual cells, can be counteracted in an even better manner in this way, and an ageing process which cannot be forecast precisely can be avoided.

The different voltages of the storage cells can be realized by setpoint values supplied by the control unit to the switching elements or control inputs of the threshold switches of the individual cells. A CAN bus can be used for example.

Advantageously the present invention allows a high level of evening out of all cells to be achieved, which leads in total to an optimized operational life span and utilization of the storage unit.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 shows an exemplary configuration of a hybrid vehicle; and

FIG. 2 shows a schematic illustration of an embodiment of a system for storing electrical energy in accordance with the present invention.

Corresponding reference characters indicate corresponding parts throughout the several views. The exemplification set out herein illustrates one embodiment of the invention, in one form, and such exemplification is not to be construed as limiting the scope of the invention in any manner.

### DETAILED DESCRIPTION OF THE INVENTION

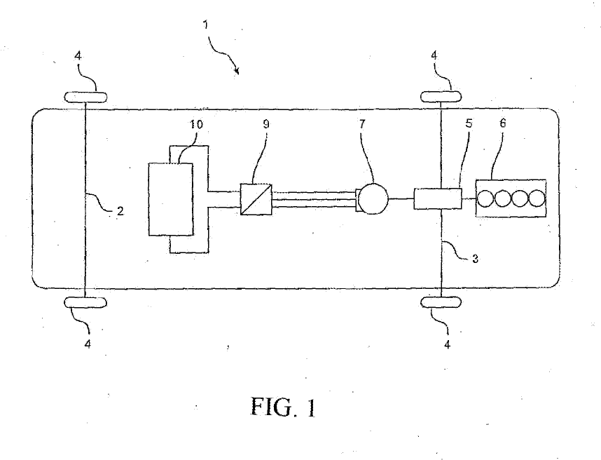

FIG. 1 shows a hybrid vehicle 1 by way of example. Vehicle 1 includes two axles 2, and 3 with two respective wheels 4. Axle 3 is a driven axle of vehicle 1, whereas axle 2 will merely be entrained in the known manner. A transmission 5 is shown for driving axle 3. Transmission 5 takes up the power from an internal combustion engine 6 and an electrical machine 7 and conducts the power to the region of driven axle 3. In the drive situation, electrical machine 7 can conduct power into the region of driven axle 3 either alone or in addition to the drive power of internal combustion engine 6, or it can support the drive of vehicle 1. Furthermore, electrical machine 7 can be operated as a generator during braking of vehicle 1 in order to reclaim power occurring during braking and to store the power accordingly. In order to provide sufficient energy content when using a city bus as a vehicle 1 also for braking processes from higher speeds, which in the case of a city bus will generally not exceed approximately 70 km/h, a system 10 is provided, in this case for storing electrical energy, which has an energy content in the magnitude of 350 to 700 Wh. As a result, this also allows converting energies into electrical energy, which are obtained during a braking process with a duration of approximately 10 seconds via electrical machine 7, which will typically lie within the magnitude of approximately 150 kW, and allows storing these energies in system 10.

For the purpose of triggering electrical machine 7 and for charging and discharging system 10 with electrical energy, the configuration according to FIG. 1 includes an inverter 9 which in the known manner is arranged with an integral control device for energy management. Inverter 9 with the integrated control device is used to respectively coordinate the energy flow between electrical machine 7 and system 10 for storing the electrical energy. The control device ensures that during braking the power obtained from electrical machine 7, which is then operated as a generator, will be stored to the highest possible extent in system 10, wherein a predetermined upper voltage limit of system 10 may generally not be exceeded. In the drive situation, the control device in inverter 9 coordinates the withdrawal of electrical energy from system 10 in order to drive electrical machine 7 by way of the withdrawn power in this reversed case. In addition to hybrid vehicle 1 which is described here, and which can be a city bus, a comparative configuration is also possible in a pure electric vehicle.

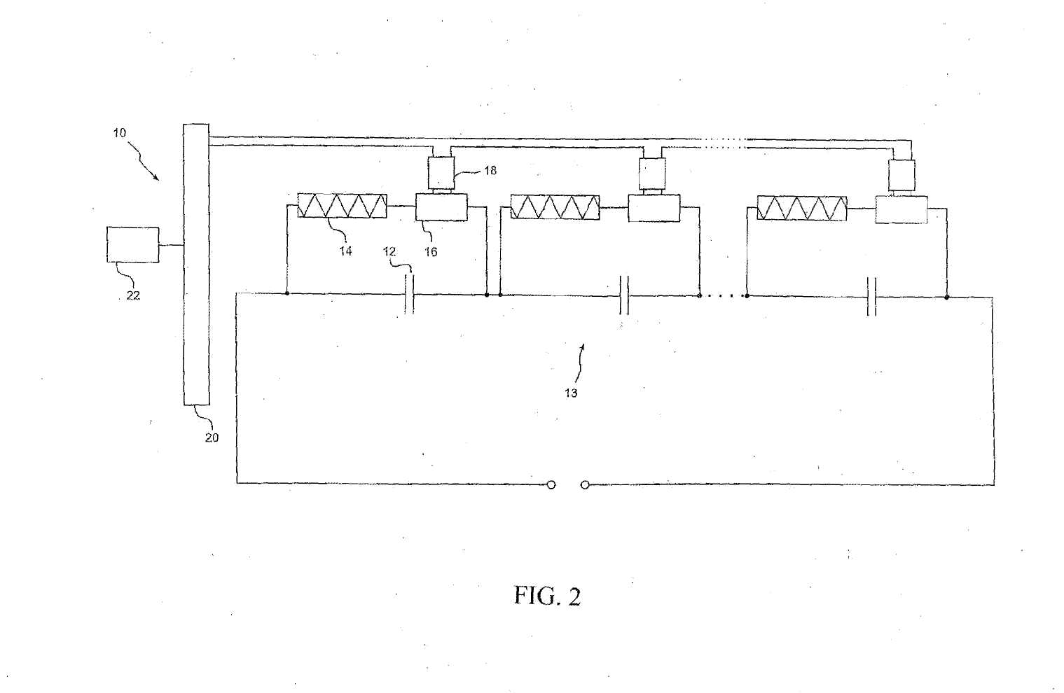

Now additionally referring to FIG. 2, there is shown a schematic sectional view of system 10 in accordance with the invention for storing electrical energy. Different types of system 10 for storing electrical energy are principally possible. Such a system 10 is typically arranged in such a way that a plurality of storage cells 12 is typically switched in series in the system 10. These storage cells can be accumulator cells and/or supercapacitors, or any random combination thereof. In the embodiment as shown here, storage cells 12 are all supercapacitors, which means they are arranged as double-layer capacitors which are used in system 10 for storing electrical energy in vehicle 1 equipped with the hybrid drive. The configuration can preferably be used in a commercial vehicle such as a bus for city/metropolitan traffic. An especially high efficiency in the storage of the electrical energy by the supercapacitors is achieved in this case by the frequent starting and braking maneuvers in conjunction with a very high mass of the vehicle, and because comparatively high currents will flow.

As already mentioned above, FIG. 2 shows storage cells 12. The drawing merely shows three storage cells 12 which are connected in series. In the aforementioned embodiment, and in the case of a respective electrical drive power of approximately 100 to 200 kW, e.g. 120 kW, there would be a total of approximately 150 to 250 storage cells 12 in a realistic configuration. If they are arranged as supercapacitors with a current upper voltage limit of approximately 2.7 V per supercapacitor and a capacitance of 3000 farads, a realistic application for the hybrid drive of a city bus would be provided.

FIG. 2 shows an embodiment of the idea in accordance with the present invention. System 10, for storing electrical power, includes a plurality of storage cells 12 which are switched in series. They are combined into a module 13. Each of storage cells 12 includes an electrical consumer in the form of an ohmic resistor 14 which is switched in parallel to the respective storage cell 12. Resistor 14 is switched in series with a switching element 16 parallel to each of storage cells 12. Switch 16 is arranged as a threshold switch. The individual switches 16 are provided with a control input 18.

Each of the control inputs 18 is connected via lines with a bus system 20, such as a CAN bus system. A control unit 22 is connected to bus system 20. Control device 22 is also connected to bus system 20, sends information to the control input 18 of threshold switches 16 and thereby enables an increase or decrease of the trip voltage, which means the threshold voltage of the threshold switches 16. A further parameter that may be influenced by control unit 22 is the opening time of threshold switch 16. It is further possible to not only send information to the control inputs by way of the bus system 20 but also to receive data from storage cells 12. The data that can be queried from storage cells 12 may concern the current voltage of storage cells 12, for example.

Another embodiment provides that the cell temperature of storage cells 12 is determined. In operation, the control unit determines in the preferred embodiment of FIG. 2 the individual temperatures of the storage cells, from assumptions on the temperature distribution within the module or the storage unit. The assumptions can originate from model-based calculations, such as a thermal model of the configuration, operational lifespan models of the storage cells and/or tests. Furthermore, control unit 22 knows the total voltage of the module or storage unit, and the voltages of the individual storage cells 12. Storage cells 12, which have a middle temperature, are preferably assigned a middle voltage such as 2.5 V, for example, by control unit 22 in operation of system 10. Storage cells 12 with a high temperature are assigned a lower voltage such as 2.42 V, for example. Storage cells 12 with a low temperature are assigned a higher voltage, such as 2.55 V, for example. The different voltages for the individual storage cells 12 are communicated by control unit 22 to control inputs 18 of threshold switches 16 via bus system 20. The voltage for system 10 for a hybrid drive remains unchanged by this measure. An evening out in the ageing of all storage cells 12 is thereby achieved, leading in total to a maximized operational life span and utilization of storage unit 10.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system (10) for storing electrical energy having several storage cells (12), each storage cell having an operating voltage, an electrical load (14) and a switching element (16) connected in series with each storage cell, the switching element (16) being closed when a threshold voltage of the storage cell is reached or exceeded, the system (10) comprising:
at least one module (13) having several storage cells (12); and
a control device (22) configured to assign a temperature to individual storage cells (12) and a module voltage to the module (13), said control device being further configured to alter the threshold voltage of the individual storage cells dependant upon the assigned temperature whilst maintaining the module voltage.

2. The system of claim 1, wherein the control device (22) determines the temperatures assigned to the storage cells (12) from model-based calculations.

3. The system of claim 2, wherein the assigned temperature is an expected temperature of the storage cell (12) which relates to at least one of a current operating state, an expected operating situations and environmental data.

4. The system of claim 3, wherein the control device (22) is further configured to at least one of determine a mean temperature of the module (13) and determine temperature differences between the storage cells (12).

5. The system of claim 4, wherein the threshold voltage can be changed by a setpoint value of the control device (22).

6. The system of claim 1, wherein the switching element (16) remains closed for a predetermined period of time after closing.

7. A method for controlling a system (10) adapted for storing electrical energy, having a plurality of storage cells (12) arranged in a module (13) and having an operating voltage, with an electrical load (14) and a switching element (16) connectable to each of the storage cells (12), the method comprising the steps of:
charging the storage cells (12);
determining of a temperature of the individual storage cells (12) of the module (13);
comparing the determined temperatures; and
lowering of the operating voltage in selected storage cells (12) having a high temperature and raising the operating voltage of other selected storage cells (12) having a low temperature whilst maintaining the module operating voltage.
